(19) United States
(12) Patent Application Publication
(10) Pub. No.: US 2022/0055502 A1
(43) Pub. Date: Feb. 24, 2022

(54) A TEMPERATURE CONTROL SYSTEM, A VEHICLE PROVIDED THEREWITH AND A METHOD FOR CONTROLLING THE OPERATION THEREOF

(71) Applicant: Scania CV AB, Södertälje (SE)

(72) Inventors: Martin MOHLIN, Stockholm (SE); Ola HALL, Stockholm (SE)

(73) Assignee: Scania CV AB, Södertälje (SE)

(21) Appl. No.: 17/279,756

(22) PCT Filed: Sep. 30, 2019
(86) PCT No.: PCT/SE2019/050939

§ 371 Date: Mar. 25, 2021

(30) Foreign Application Priority Data
Oct. 9, 2018 (SE) 1851233-5

(51) Int. Cl. B60L 58/26; G05D 23/19; B60L 58/27

(52) U.S. Cl. CPC B60L 58/26; B60L 58/27; G05D 23/1934

(57) ABSTRACT

A temperature control system for a vehicle, comprising a main circuit comprising a tubing in which there is provided a coolant, a main circuit pump configured to pump said coolant through the tubing of the main circuit in a first direction. Connected in parallel to the main circuit are a first and second sub-circuit for cooling or heating of components connected thereto. In the sub-circuits there are provided first and second pumps that pump coolant through said sub-circuits from a first end to second end at which the respective sub-circuit is connected the main circuit. The first end is downstream the second end as seen in the first direction in the first circuit.

### CROSS-REFERENCE TO RELATED APPLICATIONS

This application is a National Stage Application (filed under 35 § U.S.C. 371) of PCT/SE2019/050939, filed Sep. 30, 2019 of the same title, which, in turn claims priority to Swedish Application No. 1851233-5 filed Oct. 9, 2018 of the same title; the contents of each of which are hereby incorporated by reference.

### FIELD OF THE INVENTION

The present invention relates to a temperature control system for a vehicle, comprising
a main circuit comprising a tubing in which there is provided a coolant, a main circuit pump configured to pump said coolant through the tubing of the main circuit in a first direction, and at least one unit for cooling or heating the coolant in the main circuit,
a first sub-circuit for cooling or heating a first component, said first sub-circuit comprising a tubing that has a first end and a second end, which are connected to respective openings in the tubing of the main circuit at positions that are spaced apart from each other as seen in a longitudinal direction of the tubing of the main circuit, wherein the first end is connected to the tubing of the main circuit at a position downstream the position at which the second end is connected to the tubing of the main circuit as seen in said first direction, and
at least one second sub-circuit for cooling or heating a second component, said second sub-circuit comprising a tubing that has a first end and a second end, which are connected to respective openings in the tubing of the main circuit at positions that are spaced apart from each other as seen in a longitudinal direction of the tubing of the main circuit, wherein the first end is connected to the tubing of the main circuit at a position downstream the position at which the second end is connected to the tubing of the main circuit as seen in said first direction.

The present invention also relates to a vehicle provided with a temperature control system as defined in this application.

The present invention also relates to a method of controlling the operation of a temperature control system according to the invention.

### BACKGROUND OF THE INVENTION

When designing any coolant system which involves multiple components it is always a struggle to ensure enough flow and coolant temperature to all components. Connecting the components in series allows for the same coolant flow to all components. However as the coolant gets warmer from each component it will cool the following components less and less. If, as an alternative, the components are connected in a parallel flow the coolant temperature will be the same. However, the flow rate depends on the pressure drop of the components and lengths and diameters of hoses/pipes. It is therefore an objective to find an installation which gives the required coolant flow rate and coolant temperature to all components, the temperature of which is controlled by means of heat exchange with the coolant.

In contemporary coolant systems for vehicles most coolant systems utilizes a single pump and tries to balance the properties of all components until they find a setup which works and requires as little of over-dimensioning of the pump as possible. Using a bigger pump to increase the coolant flow rate or using a bigger radiator in order to achieve more powerful cooling of the coolant is always a solution but will also induce extra costs and extra space.

For battery installations, for example provided in a vehicle as a power source of the vehicle, it is important to ensure equal cooling of all batteries. For this purpose the batteries may require the same temperature on the coolant and the same coolant flow rate. This can be solved by placing the batteries close to each other, dimensioning the coolant pump for the given amount of batteries and arranging the tubing in parallel circuits. However this requires the batteries to be close to each other, and whenever a further battery is added to the installation, the existing pump, if not over-dimensioned, will need to be substituted to a more powerful one. Prior art solutions are thus not easily adapted to changing set ups of components that need to be cooled, or heated, by the coolant in the temperature control system.

Occasionally, there may be a need of delivering different degrees of cooling of different components in a temperature cooling system. In a system having a single pump and a plurality of parallel cooling circuits into which the coolant is pumped by said pump, such differential cooling is then solved by means of flow-regulating valves provided in the respective circuit.

### SUMMARY OF THE INVENTION

It is an object of the present invention to present a temperature control system that reduces the above-mentioned drawbacks of prior art and that presents an alternative solution to existing solutions.

The object of the invention is achieved by means a temperature control system as defined hereinabove and in the preamble of claim 1, which system is characterized in that the control unit is connected to the pump of the main circuit and to the at least one unit for cooling or heating the coolant in the main circuit and is configured to control the operation of the pump of the main circuit and said unit for cooling or heating the coolant in the main circuit on basis of input received from the first sensor and the second sensor.

For each added component to be cooled, a further sub-circuit as defined hereinabove may be added. No substitution of the pump of the main circuit may be needed in order to adapt the system to such addition of components. Different coolant flow rates can easily be achieved for the different sub-circuits by individual control of the respective pump of the sub-circuits. The idea of pumping the coolant backwards (note the position of the first and second ends of the sub-circuits and the coolant flow direction in the sub-circuits in relation to the coolant flow direction of the main circuit) from an inlet to a sub-circuit at a relative downstream position to an outlet a relative upstream position reduces the pump load on the pump of the main circuit, and enables the pump of the main circuit, and the unit for cooling or heating the coolant in the main circuit, to be activated only under circumstances when sufficient cooling, or heating, of components in any of the sub-circuits cannot be achieved only with action of the pumps of the sub-circuits. Excessive flow of coolant through the main circuit is thus avoided. The coolant of the first sub-circuit and the second sub-circuit will flow in said first direction in a portion of the tubing of the main circuit which is shared by the main circuit and the sub-circuits. Irrespective of the position of the pump in the main circuit, the inlets to the sub-circuits are located at positions at which the pressure in the main circuit is lower than the pressure at which the outlets from the sub-circuits are provided, provided that the pump in the main circuit is operating and giving rise to a flow in the main circuit. Between the outlets and the inlets there is a mixing zone, shared between the main circuit and the sub-circuits. According to one embodiment, said pump of the main circuit and the unit for cooling or heating of the coolant in the main circuit are outside said mixing zone.

The parameter reflecting the temperature may be the temperature itself (direct measurement) or any other parameter, such as a property of the component that reflects its temperature, for example electric current flowing through the component (indirect measurement). The control unit may be configured to make a temperature prediction based on repeated measurements by each sensor and thus to control the respective pump not only on basis of the momentary temperature indication but also on basis of a temperature change trend.

According to one embodiment, the control unit is configured to activate the pump of the main circuit and/or said unit for cooling or heating the coolant in the main circuit, as a response to input received from said first or second sensor, or from a sensor that measures the temperature of the coolant in the first sub-circuit and the second sub-circuit, that indicates that sufficient heating or cooling of the first component or second component is not achieved by control of the first and second pump.

According to one embodiment, the pump of the main circuit has a lower maximum output, measured in liters per minute, than the sum of the maximum output of the first and second pumps.

According to one embodiment, a portion of the tubing of the main circuit that presents the openings to which the first and second ends of the first and second sub-circuits are connected is separable from an upstream part of said tubing and a downstream part of said tubing by means of tubing connections via which it is connected to said upstream part and downstream part respectively. Said portion may thus be provided as an add-on component that could be added to an already existing system, which could then be provided with sub-circuits in accordance with the teaching of the present invention. Different such add-on portions, provided with different numbers openings could be provided depending on the number of components that are to be cooled or heated by the temperature control system.

According to one embodiment, said first component and said second component are components of a vehicle.

According to one embodiment, at least one of first component and the second component is a battery for the accumulation of electric energy.

According to one embodiment, the first component has a preferred operation temperature range a-b, and the second component has a preferred operation temperature range c-d, and that a-b overlaps c-d.

The invention also relates to a vehicle, comprising a first component which has a preferred operation temperature range a-b, and at least one second component which has a preferred operation temperature range c-d, said vehicle being characterized in that it comprises a temperature control system according to the present invention, wherein the first component is provided in connection to the first sub-circuit and configured to be heated or cooled by heat exchange with coolant flowing through the first sub-circuit, and wherein the second component is provided in connection to the second sub-circuit and configured to be heated or cooled by heat exchange with coolant flowing through the second sub-circuit.

According to one embodiment, said first component and second component is any one of
a battery for accumulation of electric energy,
a compressor,
an electric heater device,
a condenser,
power electronics.

According to one embodiment, at least one of the first and second component is a battery for the accumulation of electric energy.

The invention also relates to a method of controlling the operation of a temperature control system as defined hereinabove or hereinafter, comprising the following steps:
measuring a parameter reflecting the temperature t₁ of a first component,
comparing the measured parameter to a preferred operation temperature range a-b of the first component,
controlling the output of the first pump on basis of said comparison such that a<t₁<b,
measure a parameter reflecting the temperature t₂ of a second component,
comparing the measured parameter to a preferred operation temperature range c-d of the second component,
controlling the output of the second pump on basis of said such that c<t₂<d, and repeating said steps continuously, and
if any of the conditions a<t₁<b or c<t₂<d is not achieved by means of control of the output of the first pump or the second pump, controlling the operation of the pump of the main circuit and the operation of the unit for cooling or heating the coolant in the main circuit in addition to controlling the output of the first and second pump such that a<t₁<b and c<t₂<d.

The method is preferably implemented by use of a control unit provided with a computer program comprising a computer program code causing a computer to implement the method as disclosed hereinabove or hereinafter. The control unit preferably defines a computer program product that comprises storage medium which can be read by a computer and on which the program code is stored.

Further features and advantages of the present invention are presented in the following detailed description of an embodiment.

### BRIEF DESCRIPTION OF THE DRAWINGS

An embodiment of the present invention will now be described more in detail, by way of example, with reference to the drawing, on which:

FIG. 1 is a schematic representation of temperature control system according to the invention,

FIG. 2 is a flow chart showing essential steps of an embodiment of the method according to the present invention,

FIG. 3 is an alternative embodiment to the control system shown in FIG. 1,

FIG. 4, is a further alternative embodiment to the control system shown in FIG. 1, and

FIG. 5 is yet another alternative embodiment of the control system shown in FIG. 1.

### DETAILED DESCRIPTION OF EMBODIMENTS

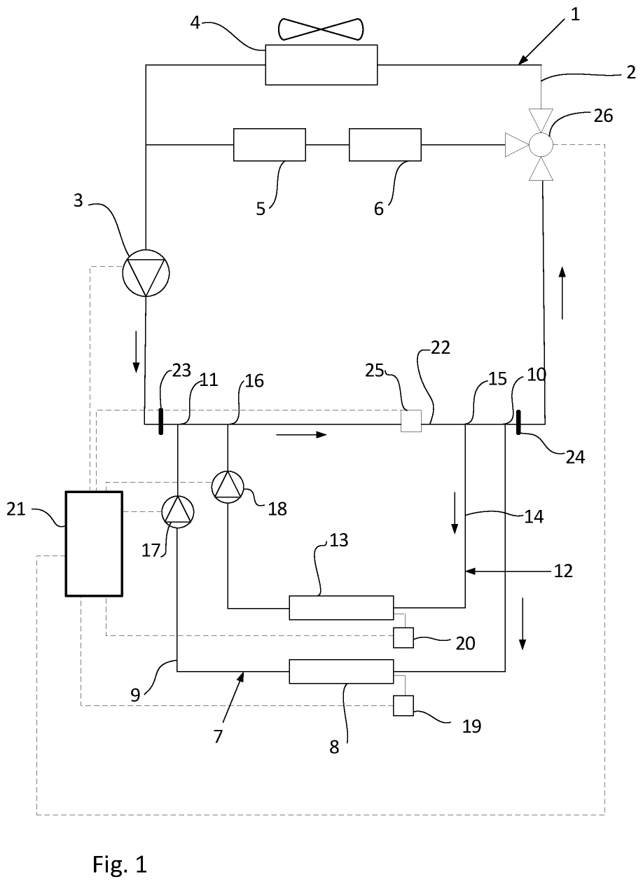

FIG. 1 is a schematic representation of a temperature control system according to the present invention. Preferably the temperature control system is arranged in a vehicle, such as a bus or truck, for the purpose of heating or cooling components, including masses of gas and/or masses of liquid. According to one embodiment, the temperature control system is configured to cool a plurality of batteries which are configured to operate as accumulators of electric energy and to act as an energy storage which is used for feeding one or more electric motors/engines configured for the propulsion of the vehicle.

The temperature control system comprises a main circuit 1 comprising tubing 2 in which there is provided a coolant. The system further comprises a main circuit pump 3 configured to pump said coolant through the tubing 2 of the main circuit 1 in a first direction, shown with an arrow in FIG. 1. The temperature control system also comprises at least one unit 4, 5, 6 for cooling or heating the coolant in the main circuit 1. Said unit may comprise a fan-cooled radiator 4, a heater 5 and/or a cooler 6. The cooler 6 may comprise an evaporator via which the coolant exchanges heat with a refrigerant of a cooling system provided with a compressor, a condenser and said evaporator. In the shown embodiment, the radiator 4 is connected in parallel with the heater 5 and the cooler 6. A directing valve 26 is provided for controlling coolant flow to the radiator 4 and the heater 5 and cooler 6. Other set ups and arrangements are of course conceivable. For example, the unit for heating or cooling may comprise at least one further circuit from which coolant of predetermined temperature is introduced into the main circuit. Such further circuits then, per definition, becomes part of the main circuit disclosed in this application.

In addition to the main circuit 1, the temperature control system also comprises a first sub-circuit 7 for cooling or heating a first component 8, said first sub-circuit comprising a tubing 9 that has a first end 10 and a second end 11, which are connected to respective openings in the tubing 2 of the main circuit at positions that are spaced apart from each other as seen in a longitudinal direction of the tubing of the main circuit. The first end 10 is connected to the tubing 2 of the main circuit 1 at a position downstream the position at which the second 11 end is connected to the tubing 2 of the main circuit 1 as seen in said first direction.

The temperature control system also comprises a second sub-circuit 12 for cooling or heating a second component 13, said second sub-circuit 12 comprising a tubing 14 that has a first end 15 and a second end 16, which are connected to respective openings in the tubing 2 of the main circuit 1 at positions that are spaced apart from each other as seen in a longitudinal direction of the tubing of the main circuit 1. The first end 15 is connected to the tubing 2 of the main circuit 1 at a position downstream the position at which the second 16 end is connected to the tubing 2 of the main circuit 1 as seen in said first direction.

The first ends 10, 15 are located downstream the second ends 11, 16 as seen in the first direction and, in this specific case, as seen from the pump 3 of the main circuit. There is a mixing zone in the first circuit 1 between the first ends 10, 15 and the second ends 11, 16, which is shared by the main circuit 1 and the first and second sub-circuits. The mixing zone should have a volume above a predetermined threshold value in order to enable coolant flowing through the sub-circuits to be mixed in said zone. According to one embodiment, the first component 8 has a preferred operation temperature range a-b, and the second component 13 has a preferred operation temperature range c-d, wherein a-b overlaps c-d.

There is also provided a sensor 25 for sensing the temperature of the coolant downstream the second ends 11, 16 of the first and second sub-circuits 7, 13 and upstream the respective first and second component 8, 13 as seen in said first direction. Alternatively the sensor 25 is supplemented or replaced by corresponding sensors arranged for the measurement of the coolant temperature in the first and second sub-circuits 7, 13 downstream the first ends 10, 15 of the first and second sub-circuits 7, 13, but upstream the first and second components 8, 13 as seen in the flow directions generated in the first and second sub-circuits 7, 12.

Further to the above-mentioned features, the first sub-circuit 7 comprises a first pump 17 configured to pump a coolant in a direction from said first end 10 of the tubing 9 of the first sub-circuit 7 to the second end 11 of the first sub-circuit 7. The coolant pumped through the first sub-circuit is coolant shared with the main circuit.

The second sub-circuit 12 comprises a second pump 18 configured to pump a coolant in a direction from said first end 15 of the tubing 14 of the second sub-circuit 12 to the second end 16 of the second sub-circuit 12.

The temperature control system further comprises a first sensor 19 configured to measure a parameter reflecting the temperature t₁ of said first component 8 and, a second sensor 20 configured to measure a parameter reflecting the temperature t₂ of said second component 13. There is also provided a control unit 21 which is connected to the first sensor 19 and to the second sensor 20 and which is configured to control the operation of the first pump 17 on basis of input received from the first sensor 19 and to control the operation of the second pump 18 on basis of input received from the second sensor 20.

The control unit 21 is connected to the pump 3 of the main circuit 1 and to the at least one unit 4, 5, 6 for cooling or heating the coolant in the main circuit 1 and is configured to control the operation of the pump 3 of the main circuit 1 and said unit 4, 5, 6 for cooling or heating the coolant in the main circuit 1 on basis of input received from the first sensor 19 and the second sensor 20. The control unit is also connected to and configured to control the directing valve 26.

The control unit 21 is configured to activate the pump 3 of the main circuit 1 and/or said unit 4, 5, 6 for cooling or heating the coolant in the main circuit 1, as a response to input received from said first or second sensor 19, 20 that indicates that sufficient heating or cooling of the first component 8 or second component 13 is not achieved by control of the first and second pump 17, 18.

A portion 22 of the tubing 2 of the main circuit 1 that presents the openings to which the first and second ends 10, 11, 15, 16 of the first and second sub-circuits 8, 12 are connected is separable from an upstream part of said tubing and a downstream part of said tubing 2 by means of tube connections 23, 24 via which it is connected to said upstream part and downstream part respectively. The portion 22 carrying said openings thus forms an easily replaceable unit which can be replaced to another corresponding unit with another setup of openings, depending on the need.

The term “tubing” as applied in this disclosure should be regarded in a wide sense and may include all sorts of structural elements that define a channel through which a coolant may flow. A tubing as used in this disclosure may also comprise a plurality of structural elements that together define the tubing, said structural elements not necessarily having the traditional geometric tubular shape of a tube.

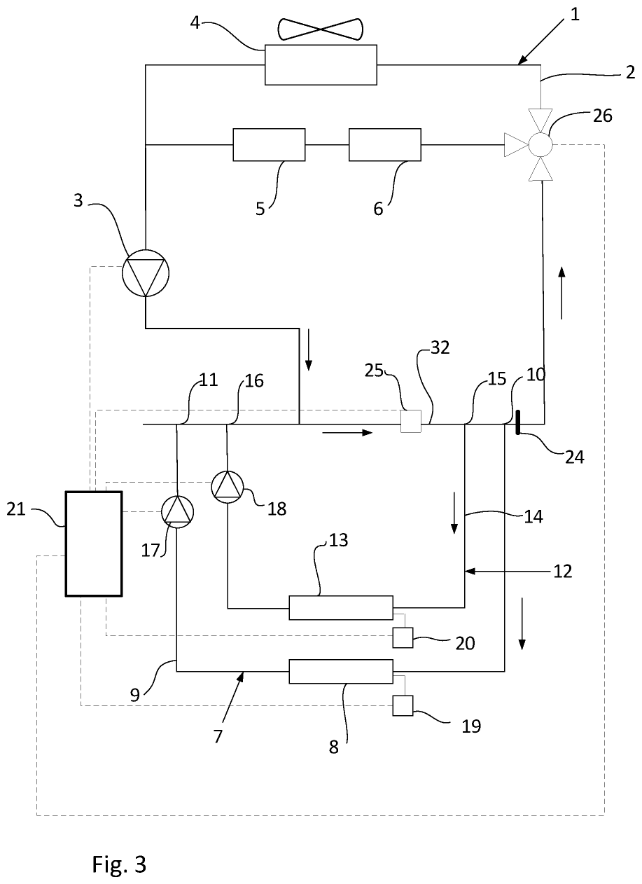

FIG. 3 shows an alternative embodiment, comprising a piece of tubing 32 to which the first and second ends 10, 11, 15, 16 of the first and second sub-circuits 8, 12 are connected in the same way as in the embodiment shown in FIG. 1. However, the embodiment shown in FIG. 3 differs from the embodiment shown in FIG. 1 in that the upstream part of the tubing 2 of the main circuit 1 is connected to the piece of tubing 32 at a point between the first ends 10, 15 and the seconds ends 11, 16 of the sub-circuits 7, 12. There is still a mixing zone in which coolant from the main circuit 1 and the sub-circuits 7, 12 is mixed.

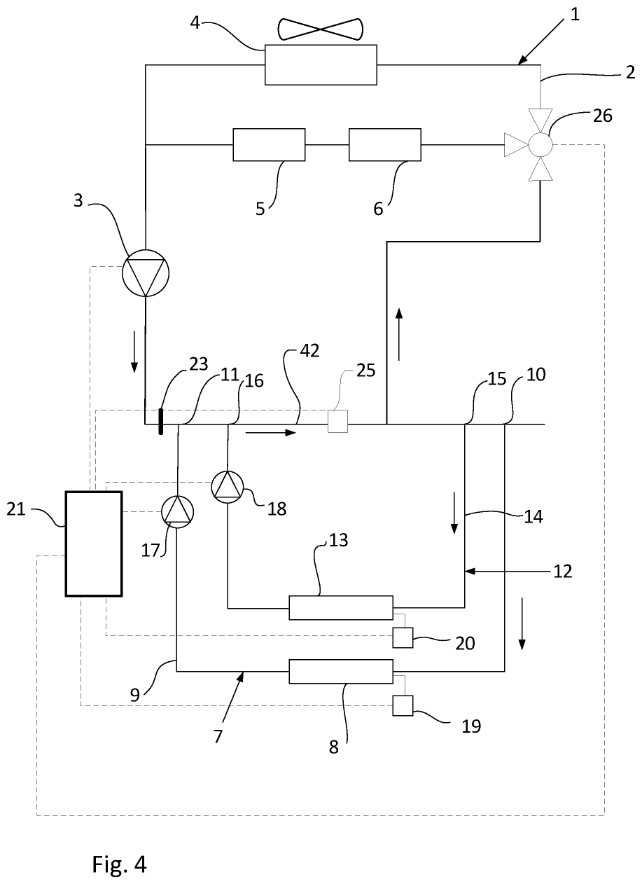

FIG. 4 shows yet another embodiment, comprising a piece of tubing 42 to which the first and second ends 10, 11, 15, 16 of the first and second sub-circuits 8, 12 are connected in the same way as in the embodiment shown in FIG. 1. However, the embodiment shown in FIG. 4 differs from the embodiment shown in FIG. 1 in that the downstream part of the tubing 2 of the main circuit 1 is connected to the piece of tubing 42 at a point between the first ends 10, 15 and the seconds ends 11, 16 of the sub-circuits 7, 12. There is still a mixing zone in which coolant from the main circuit 1 and the sub-circuits 7, 12 is mixed.

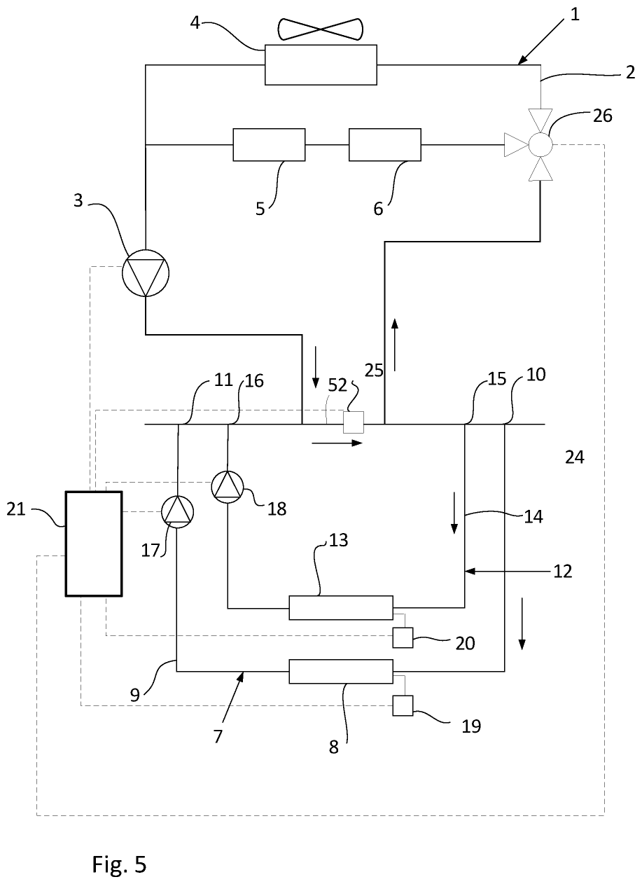

FIG. 5 shows yet another embodiment, comprising a piece of tubing 52 to which the first and second ends 10, 11, 15, 16 of the first and second sub-circuits 8, 12 are connected in the same way as in the embodiment shown in FIG. 1. However, the embodiment shown in FIG. 5 differs from the embodiment shown in FIG. 1 in that both the upstream part and the downstream part of the tubing 2 of the main circuit 1 are connected to the piece of tubing 52 at respective points between the first ends 10, 15 and the seconds ends 11, 16 of the sub-circuits 7, 12. The upstream part of the tubing 2 of the main circuit 1 is connected closer to the second ends 11, 15 of sub-circuits 7 12 than is the downstream part of the tubing 2 of the main circuit 1. As a result thereof, there is still a mixing zone in which coolant from the main circuit 1 and the sub-circuits 7, 12 is mixed.

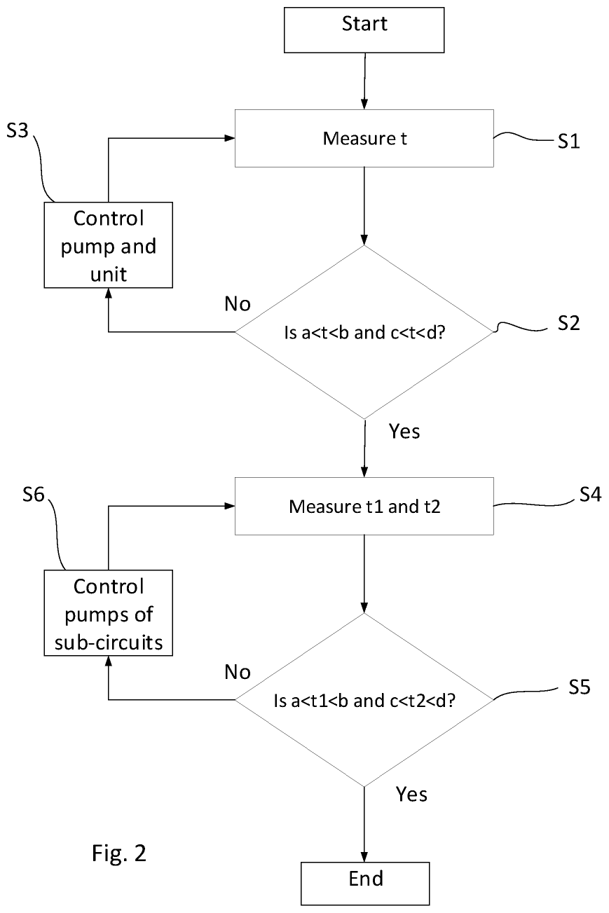

FIG. 2 shows a flow chart in which steps of the method according to the present invention is presented. The method comprises the following steps:

Measuring the temperature t of the coolant downstream the second ends 11, 16 of the first and second sub-circuits 7, 12 as seen in said first direction, either by measurement in said mixing zone and/or by individual measurement of the coolant temperature in the first and second sub-circuits 7, 12 downstream the first ends 10, 15 of the first and second sub-circuits 7, 12, but upstream the first and second components 8, 13, box S1.

Comparing the measured coolant temperature t with a preferred operation temperature range a-b of the first component 8 and with a preferred operation temperature range c-d of the second component 13, box S2.

If the measured coolant temperature t is outside the ranges a-b and/or c-d, then operation of the pump 3 of the main circuit 1 and said unit 4, 5, 6 for cooling or heating the coolant in the main circuit 1 should be controlled such that the measured coolant temperature t becomes inside said ranges a-b and c-d, box S3.

Measuring a first parameter reflecting the temperature t₁ of the first component 8 in the first sub-circuit, and measuring a second parameter reflecting the temperature t₂ of the second component 13 in the second sub-circuit, box S4.

Comparing the temperature t₁ reflected by the first measured parameter to the preferred operation temperature range a-b of the first component 8, to determine if a<t₁<b, and comparing the temperature t₂ reflected by the second measured parameter to the preferred operation temperature range c-d of the second component 13 to determine if c<t₂<d, box S5.

If a<t₁<b is not fulfilled, controlling the output of the first pump 17 of the first sub-circuit 7 on basis of said comparison such in order to obtain that a<t₁<b, and if c<t₂<d, controlling the output of the second pump 18 on basis of said such that c<t₂<d, box S6.

These steps are preferably performed by the action of the control unit 21 in interaction with the first and second sensors 19, 20, the sensor 25 for measuring the coolant temperature, the pump 3 in the main circuit 1, the unit 4, 5, 6 for cooling or heating the coolant in the main circuit 1, and the first and second pumps 17, 18.

It should be stated that if the temperature t of the coolant is not within the ranges a-b and c-d, this will be interpreted by the control unit as an indication that sufficient heating or cooling of the first component 8 or second component 13 is not achieved by control of the first and second pumps 17, 18 alone, but that added functionality of the pump 3 in the main circuit 1 and the unit 4, 5, 6 for cooling or heating the coolant in the main circuit 1 is needed.

Although the invention has been exemplified only by showing an embodiment in which there are only two sub-circuits it should be understood that the intended scope of protection also includes solutions in which there are numerous such sub-circuits, and by means of which the temperature of a plurality of components, including batteries, are controlled. Controlling the temperature of a component also includes controlling the temperature of a mass of gas or liquid, preferably by controlling the temperature of a component that in its turn affects the temperature of the mass of gas or liquid.

It should be added that of course, the claimed scope of protection also covers designs in which there are further components/parts in each respective circuit. Such components/parts may be provided serially or in parallel with the components/parts that have been disclosed in this disclosure.

1. A temperature control system for a vehicle, comprising:
a main circuit comprising a tubing in which there is provided a coolant, a main circuit pump configured to pump said coolant through the tubing of the main circuit in a first direction, and at least one unit for cooling or heating the coolant in the main circuit;
a first sub-circuit for cooling or heating a first component, said first sub-circuit comprising a tubing that has a first end and a second end, which are connected to respective openings in the tubing of the main circuit at positions that are spaced apart from each other as seen in a longitudinal direction of the tubing of the main circuit, wherein the first end of the tubing of the first sub-circuit is connected to the tubing of the main circuit at a position downstream of a position at which the second end of the tubing of the first sub-circuit is connected to the tubing of the main circuit as seen in said first direction; and
at least one second sub-circuit for cooling or heating a second component said second sub-circuit comprising a tubing that has a first end and a second end, which are connected to respective openings in the tubing of the main circuit at positions that are spaced apart from each other as seen in the longitudinal direction of the tubing of the main circuit, wherein the first end of the tubing of the second sub-circuit is connected to the tubing of the main circuit at a position downstream of a position at which the second end of the tubing of the second sub-circuit is connected to the tubing of the main circuit as seen in said first direction,
wherein:
the first sub-circuit comprises a first pump configured to pump coolant in a direction from said first end of the tubing of the first sub-circuit to the second end of the tubing of the first sub-circuit, and
the second sub-circuit comprises a second pump configured to pump coolant in a direction from said first end of the tubing of the second sub-circuit to the second end of the tubing of the second sub-circuit;
a first sensor configured to measure a parameter reflecting a temperature t₁ of said first component;
a second sensor configured to measure a parameter reflecting a temperature t₂ of said second component; and
a control unit which is connected to the first sensor and to the second sensor and which is configured to control operation of the first pump based on input received from the first sensor and to control operation of the second pump based on input received from the second sensor, and wherein the control unit is connected to the pump of the main circuit and to the at least one unit for cooling or heating the coolant in the main circuit and is configured to control operation of the pump of the main circuit and said unit for cooling or heating the coolant in the main circuit based on input received from the first sensor and the second sensor.

2. A temperature control system according to claim 1, wherein the control unit is configured to activate the pump of the main circuit and/or said unit for cooling or heating the coolant in the main circuit, as a response to input received from said first sensor or from said second sensor, or from a sensor that measures a temperature of the coolant in the first sub-circuit and/or the second sub-circuit indicating that sufficient heating or cooling of the first component or second component is not achieved by control of the first and second pump.

3. A temperature control system according to claim 1, wherein the pump of the main circuit has a lower maximum output, measured in liters per minute, than a sum of a maximum output of the first and the second pumps.

4. A temperature control system according to claim 1, wherein a portion of the tubing of the main circuit that presents openings to which the respective first and second ends of the first and second sub-circuits are connected is separable from an upstream part of said tubing of the main circuit and a downstream part of said tubing of the main circuit by means of tubing connections.

5. A temperature control system according to claim 1, wherein said first component and said second component are components of a vehicle.

6. A temperature control system according to claim 5, wherein at least one of the first component and the second component is a battery for accumulation of electric energy.

7. A temperature control system according to claim 1, wherein characterized in that the first component has a preferred operation temperature range a-b, and the second component has a preferred operation temperature range c-d, and wherein range a-b overlaps range c-d.

8. A vehicle, comprising a temperature control system, comprising:
a main circuit comprising a tubing in which there is provided a coolant, a main circuit pump configured to pump said coolant through the tubing of the main circuit in a first direction, and at least one unit for cooling or heating the coolant in the main circuit;
a first sub-circuit for cooling or heating a first component, said first sub-circuit comprising a tubing that has a first end and a second end, which are connected to respective openings in the tubing of the main circuit at positions that are spaced apart from each other as seen in a longitudinal direction of the tubing of the main circuit, wherein the first end of the tubing of the first sub-circuit is connected to the tubing of the main circuit at a position downstream of a position at which the second end of the tubing of the first sub-circuit is connected to the tubing of the main circuit as seen in said first direction;
at least one second sub-circuit for cooling or heating a second component, said second sub-circuit comprising a tubing that has a first end and a second end, which are connected to respective openings in the tubing of the main circuit at positions that are spaced apart from each other as seen in the longitudinal direction of the tubing of the main circuit, wherein the first end of the tubing of the second sub-circuit is connected to the tubing of the main circuit at a position downstream of a position at which the second end of the tubing of the second sub-circuit is connected to the tubing of the main circuit as seen in said first direction,
wherein:
the first sub-circuit comprises a first pump configured to pump coolant in a direction from said first end of the tubing of the first sub-circuit to the second end of the tubing of the first sub-circuit, and
the second sub-circuit comprises a second pump configured to pump coolant in a direction from said first end of the tubing of the second sub-circuit to the second end of the tubing of the second sub-circuit;
a first sensor configured to measure a parameter reflecting a temperature t₁ of said first component;
a second sensor configured to measure a parameter reflecting a temperature t₂ of said second component; and
a control unit which is connected to the first sensor and to the second sensor and which is configured to control operation of the first pump based on input received from the first sensor and to control operation of the second pump based on input received from the second sensor, and wherein the control unit is connected to the pump of the main circuit and to the at least one unit for cooling or heating the coolant in the main circuit and is configured to control operation of the pump of the main circuit and said unit for cooling or heating the coolant in the main circuit based on input received from the first sensor and the second sensor.

9. A vehicle according to claim 8, wherein said first component and said second component is any one of:
a battery for accumulation of electric energy;
a compressor;
an electric heater device;
a condenser; or
power electronics.

10. A vehicle according to claim 9, wherein at least one of the first component or the second component is a battery for the accumulation of electric energy.

11. A method of controlling operation of a temperature control system comprising:
a main circuit comprising a tubing in which there is provided a coolant, a main circuit pump configured to pump said coolant through the tubing of the main circuit in a first direction, and at least one unit for cooling or heating the coolant in the main circuit;
a first sub-circuit for cooling or heating a first component, said first sub-circuit comprising a tubing that has a first end and a second end, which are connected to respective openings in the tubing of the main circuit at positions that are spaced apart from each other as seen in a longitudinal direction of the tubing of the main circuit, wherein the first end of the tubing of the first sub-circuit is connected to the tubing of the main circuit at a position downstream of a position at which the second end of the tubing of the first sub-circuit is connected to the tubing of the main circuit as seen in said first direction;
at least one second sub-circuit for cooling or heating a second component, said second sub-circuit comprising a tubing that has a first end and a second end, which are connected to respective openings in the tubing of the main circuit at positions that are spaced apart from each other as seen in the longitudinal direction of the tubing of the main circuit, wherein the first end of the tubing of the second sub-circuit is connected to the tubing of the main circuit at a position downstream of a position at which the second end of the tubing of the second sub-circuit is connected to the tubing of the main circuit as seen in said first direction,
wherein:
the first sub-circuit comprises a first pump configured to pump coolant in a direction from said first end of the tubing of the first sub-circuit to the second end of the tubing of the first sub-circuit, and
the second sub-circuit comprises a second pump configured to pump coolant in a direction from said first end of the tubing of the second sub-circuit to the second end of the tubing of the second sub-circuit;
a first sensor configured to measure a parameter reflecting a temperature t₁ of said first component;
a second sensor configured to measure a parameter reflecting a temperature t₂ of said second component; and
a control unit which is connected to the first sensor and to the second sensor and which is configured to control operation of the first pump based on input received from the first sensor and to control operation of the second pump based on input received from the second sensor, and wherein the control unit is connected to the pump of the main circuit and to the at least one unit for cooling or heating the coolant in the main circuit and is configured to control operation of the pump of the main circuit and said unit for cooling or heating the coolant in the main circuit based on input received from the first sensor and the second sensor,
wherein said method comprises:
a) measuring a parameter reflecting a temperature t₁ of a first component;
b) comparing the measured parameter reflecting the temperature t₁ of the first component to a preferred operation temperature range a-b of the first component;
c) controlling an output of the first pump on basis of said comparison such that so as to control the temperature of the first component t₁ toward the preferred operation temperature range a-b (a<t₁<b);
d) measuring a parameter reflecting a temperature t₂ of the second component;
e) comparing the measured parameter reflecting the temperature t₂ of the second component to a preferred operation temperature range c-d of the second component;
f) controlling an output of the second pump on a basis of said comparison so as to control the temperature of the second component t₂ toward the preferred operation temperature range c-d (c<t₂<d);
repeating said a) thru f) steps substantially continuously; and
if any of the conditions a<t₁<b or c<t₂<d is not achieved by means of control of the output of the first pump or the second pump, controlling operation of the pump of the main circuit and operation of the unit for cooling or heating the coolant in the main circuit in addition to controlling the output of the first and second pump such that a<t₁<b and c<t₂<d.

12. A temperature control system according to claim 1, wherein said control unit is configured to perform the following operations:
a) measure a parameter reflecting a temperature t₁ of a first component;
b) compare the measured parameter reflecting the temperature t₁ of the first component to a preferred operation temperature range a-b of the first component;
c) controlling an output of the first pump on basis of said comparison so as to control the temperature of the first component t₁ toward the preferred operation temperature range a-b (a<t₁<b);
d) measure a parameter reflecting a temperature t₂ of the second component;
e) comparing the measured parameter reflecting the temperature t₂ of the second component to a preferred operation temperature range c-d of the second component;
f) controlling an output of the second pump on a basis of said comparison so as to control the temperature of the second component t₂ toward the preferred operation temperature range c-d (c<t₂<d);
repeating said a) thru f) steps substantially continuously; and
if any of the conditions a<t₁<b or c<t₂<d is not achieved by means of control of the output of the first pump or the second pump, controlling operation of the pump of the main circuit and operation of the unit for cooling or heating the coolant in the main circuit in addition to controlling the output of the first and second pump such that a<t₁<b and c<t₂<d.

13. A vehicle according to claim 8, wherein said control unit is configured to perform the following operations:
a) measure a parameter reflecting a temperature t₁ of a first component;
b) compare the measured parameter reflecting the temperature t₁ of the first component to a preferred operation temperature range a-b of the first component;
c) controlling an output of the first pump on basis of said comparison so as to control the temperature of the first component t₁ toward the preferred operation temperature range a-b (a<t₁<b);
d) measure a parameter reflecting a temperature t₂ of the second component;
e) comparing the measured parameter reflecting the temperature t₂ of the second component to a preferred operation temperature range c-d of the second component;
f) controlling an output of the second pump on a basis of said comparison so as to control the temperature of the second component t₂ toward the preferred operation temperature range c-d (c<t₂<d);
repeating said a) thru f) steps substantially continuously; and
if any of the conditions a<t₁<b or c<t₂<d is not achieved by means of control of the output of the first pump or the second pump, controlling operation of the pump of the main circuit and operation of the unit for cooling or heating the coolant in the main circuit in addition to controlling the output of the first and second pump such that a<t₁<b and c<t₂<d.
